(19) United States
(12) Patent Application Publication
(10) Pub. No.: US 2002/0047049 A1
(43) Pub. Date: Apr. 25, 2002

(54) Authentication device with self-personalization capabilities

(76) Inventors: David Perron, Quebec (CA); Yannick Le Devehat, Quebec (CA); Jean-Philippe Gauvin, Cap-Rouge (CA)

Correspondence Address: HESLIN ROTHENBERG FARLEY & MESITI PC, 5 COLUMBIA CIRCLE, ALBANY, NY, 12203, US

(21) Appl. No.: 09/951,127

(22) Filed: Sep. 13, 2001

Related U.S. Application Data
(60) Provisional application No. 60/230,914, filed on Sep. 13, 2000.

(51) Int. Cl. G06K 19/06

(52) U.S. Cl. 235/492

(57) ABSTRACT

The authentication device, for example a card, is provided with the capability of generating its own unique personalization data. Each device, prior to the personalization phase, is advantageously identical to any other device of a same batch. The device generates a random internal number using one or more different methods and in such a way that the internal number cannot be predicated and it is statistically improbable another device has an identical internal number. Segments of the random internal number are used to form the personalization data, for instance a serial number and key number. The random internal number can also be inserted in a mathematical algorithm, for example a one-way hashing function, to generate another number or other numbers to be used as the personalization data. Once generated, the personalization data are recorded in a memory.

The device may be further provided with unique seed number, either as part of the manufacture process or at a later date through an ISO 7816 interface, if any. The seed number is later combined or otherwise used with the random internal number to generate the personalization data.

### CROSS-REFERENCE WITH PRIOR APPLICATION

The present application claims the benefits of U.S. provisional patent application No. 60/230,914 filed Sep. 13, 2000, which is hereby incorporated by reference.

### FIELD OF THE INVENTION

The present invention relates to an authentication device, preferably having the dimensional format established for “smart cards” in International Standard ISO 7816, which device provides data through a terminal for the purpose of establishing the authorization of an end user to conduct a transaction with a system.

### BACKGROUND

Credit cards and debit cards are widely used to conduct transactions with computerized systems. In the conduct of such transactions, a conventional credit card is typically authenticated by simple possession of the card. Only in rare instances the end user is asked to provide a proof that he or she is indeed the legitimate end user or the user's signature is verified in a thorough and adequate manner. A conventional debit card is somewhat more secure since it is authenticated by a personal identification number (PIN) in addition to the possession thereof. However, many people do not properly hide the keys when they input in their PIN on a terminal so that a person standing nearby or even the cashier may learn it. Some criminals even record PINs using a hidden camera.

In both above-mentioned cases, it is possible for criminals to create fake cards and use them in addition to the original and valid cards since the data unique to each card is a fixed string that can be recorded and copied from its magnetic stripe using a portable or otherwise illicit magnetic stripe reader. The recording or copy can then be used to make a fraudulent access to a transaction system, usually without any difficulties, since the system typically assumes that any valid data stream comes from a genuine card. Consequently, a counterfeited credit or debit card may be used to illegally purchase valuable goods or services, generally until the time the theft is detected by proper authorities or when the credit limit is reached.

“Smart cards” solve some of the inherent security weaknesses of conventional credit and debit cards by being capable of exchanging information with a transaction system in a secure manner. Among others, smart cards are able to communication with a transaction system using information that are unique to each transaction.

The transfer of information between a smart card and a transaction system may be achieved in various ways. The most general technique currently employed uses the ISO 7816 bi-directional electrical interface provided on the card and connected to an electronic circuitry embedded in the card. The ISO 7816 interface exchanges data with a corresponding smart card reader. Yet, further techniques utilize an acoustic interface, generally operating at telephone voice frequencies, to enable communication between the card and a transaction system by acoustic coupling through a telephone handset or any other suitable communication terminal. Various cards have been proposed utilizing one or more of these techniques for achieving communication with different types of terminal interfaces and transaction systems.

Generally, each card is designed to be unique and for this reason, the cards found in prior art are preloaded with unique personalization data prior to issuing the cards to end users. The personalization data are introduced into the memory of the card from the exterior through an electronic connection. The personalization data, or a suitable derivative thereof, are known by the corresponding transaction systems so as to authenticate a card and decipher the data streams sent by the card in the course of a transaction. An example of such a system is described in U.S. Pat. No. 5,216,716 to Bernard.

### SUMMARY

The object of the present invention is to provide an authentication device, for example a card, having the capability of generating its own unique personalization data, preferably after the device is completely manufactured and before it is sent to the end user. The personalization data typically include a serial number and a key number.

Each device, prior to the personalization phase, is advantageously identical to any other device of a same batch. The device randomly generates an internal number using one or more different methods. The random internal number is generated in such a way that it cannot be predicted and it is statistically improbable that two devices have identical random internal numbers. This random internal number, or at least a portion thereof, can be either divided to form the serial number and the key number, or can be inserted in a mathematical algorithm to generate other numbers to be used as the personalization data. Once generated, the personalization data are recorded in a memory.

Advantageously, the device may be provided with unique seed number, either as part of the manufacturing process or at a later time through the ISO 7816 interface, if any. The seed number increases the randomness of the personalization data. During the personalization phase, the seed number is combined or otherwise used with the random internal number, for example through a one-way hashing function, to generate the personalization data.

Further features of the authentication device and corresponding method will be apparent from following detailed description of preferred and possible embodiments thereof.

### BRIEF DESCRIPTION OF THE FIGURES

FIG. 1 is a plan view of a device in accordance with a preferred and possible embodiment;

FIG. 2 is a side elevation view of the device, with its thickness exaggerated to facilitate illustration;

FIG. 3 is a simplified schematic circuit diagram of the device in accordance with a first embodiment thereof; and

FIG. 4 is a simplified schematic circuit diagram of the device in accordance with a second embodiment thereof.

### DETAILED DESCRIPTION

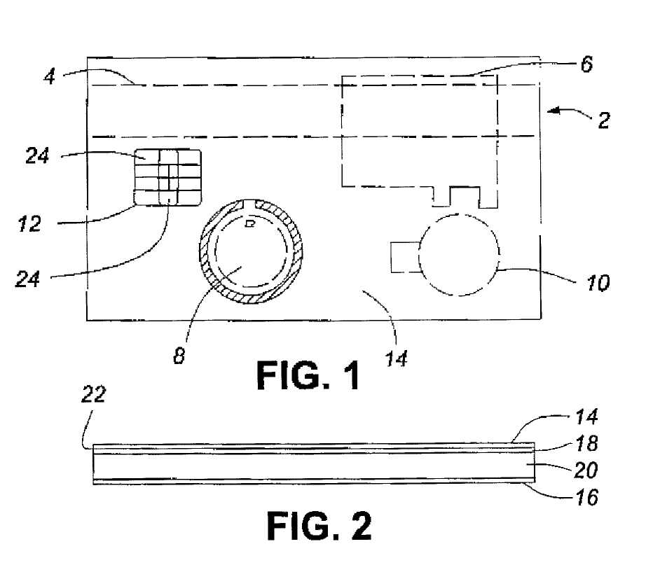

FIGS. 1 and 2 show a preferred embodiment of the authentication device, in this case a card 2. This card 2 is preferably built to be conformed with the ISO 7816 standard or any subsequent version or applicable standard. Thus, the card 2 is preferably designed to use the existing reader infrastructure or network and has a thickness of about 0.76 mm, as specified in the standard. The card 2 may also comprise a magnetic stripe 4 to transmit some information in a conventional fashion if required. Of course, it is possible to design a card which is for use only in a specific application and that would not be compatible with conventional readers.

Depending on the specific needs, the card 2 comprises a battery 6 having enough energy to last for the life thereof, at least one data output device, such as an acoustic transducer element 8 and/or an ISO 7816 interface 12, a finger-operated switch 10, and a microcontroller 26 which is preferably mounted behind an ISO 7816 interface 12, if any. The ISO 7816 interface 12 includes standardized contact surfaces or pads 24 in an area presented through a front surface layer 14 of the card 2. All components are electrically connected together, for instance through a flexible circuit board embedded in the card 2. The battery 6 may be omitted if the card 2 is designed to be used only by inserting it in a smart card reader from which it receives electrical power through the ISO 7816 interface 12.

The microcontroller 26 includes a core 33 where the internal processing occurs. Preferably, it also includes an internal clock 34 and an I/O interface 36 to which the acoustic transducer element 8 and/or the ISO 7816 interface 12 are connected. Some of the pads 24 of the ISO 7816 interface 12 can also be linked to the microcontroller 26 through other connections thereof

The exact kind of microcontroller 26 depends essentially on the available models when the card is designed and the design requirements. A possible model for the microcontroller 26 is model MSP430P112 from TEXAS INSTRUMENTS. The microcontroller 26 comprises a program memory 30 that is programmable through programming readouts or through the ISO 7816 interface 12, depending on the model. However, such programming is not required in the case a mask-programmed microcontroller, such as model MSP430C112, which is more suitable for mass-produced cards. The microcontroller 26 is programmed with code to provide desired functionality of the card 2 to communicate with a transaction system through a terminal. Such communication is typically through either the ISO 7816 interface 12 or the acoustic transducer element 8. The memory 30 is for example a one-time programmable memory (OTP), a read-only memory (ROM), a FLASH memory, erasable programmable read-only memory (EPROM) or an electrically erasable programmable read-only memory (EEPROM). The program memory 30 can also be located in a module outside the microcontroller 26 itself. The exact design of the memory and the nature thereof is something well known in the art and does not need to be further detailed herein.

It should be noted that the design of the battery 6 may be different from that shown in FIG. 1, for example to allow letters, numbers and symbols to be embossed on the card 2, if required, as in the case of most conventional credit or debit cards. The layout of the other components on the card 2 may be different. The data output device can also be different from an acoustic transducer element or an ISO 7816 interface.

The acoustic transducer element 8 is designed to generate tone sequences, generally at voice frequencies, enabling communication between the card 2 and a transaction system by acoustic coupling through a telephone handset or any other suitable communication terminal. It may also be used at other frequencies, in particular higher frequencies, depending on the applications.

The card 2 is manufactured in accordance with any known techniques in the art, such as by injection, machining, cold or hot lamination, molding, or even a combination of them. It preferably features a laminated construction, which essentially comprises a core layer sandwiched between two or more other layers. For instance, it may comprise a front layer 14, a rear layer 16, a circuit board layer 18 and a core layer 20, as shown in FIG. 2. The layers are connected together by layers of adhesive, such as the layer 22. The adhesive may be, for instance, a glue or a filler, activated by light, heat or both. The components necessary for the card 2 to function are thus embedded or otherwise made inaccessible therein. The various layers are preferably made of a plastic material, such as PCV, polyester, ABS or the like. The faces of the card 2 may be printed either in advance or at a later time.

The term <<terminal>> refers to almost any kind of apparatus through which the card 2, or device, may communicate in order to reach the transaction system. It may be located at a point-of-sale (POS) or any other location, particularly when the terminal is a telephone apparatus. Also, the expression <<transaction system>> means any computer or cluster of computers, as well as any similar systems, carrying out the tasks of authentication and the ones related to the transaction itself. The term <<transaction>> relates to any relevant task and is not limited to monetary transactions. For instance, it may include granting an access, such as unlocking a door, or anything else of similar nature. Further, the expression <<authentication device>> includes cards, tokens or any other devices for which the present invention may be useful.

Preferably, the card 2 is temporarily activated, i.e. switched on, using a pressure switch 10 which typically comprises a flexible membrane or a piezoelectric pressure sensor closing a circuit when a finger pressure is applied. This sends an activation signal to the microcontroller 26. Rather than simply switching on the card 2, it is also possible to provide a keypad for a PIN or any other additional security feature, including for instance a biometrics sensor. Other kinds of switches may be used as well.

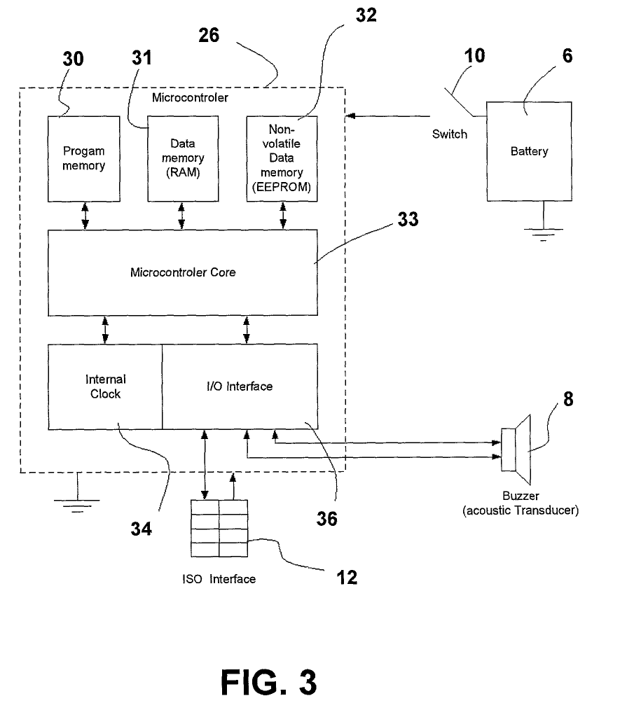

In FIG. 3, the switch 10 is simply located between the battery 6 and the microcontroller 26. Closing the switch 10 powers the microcontroller 26 for a brief moment, which is generally enough for carrying out its functions. FIG. 3 also shows a random-access memory (RAM) 31 which is used by the microcontroller 26. In the embodiment illustrated in FIG. 3, the personalization data are stored in a non-volatile data memory 32, more particularly an EEPROM.

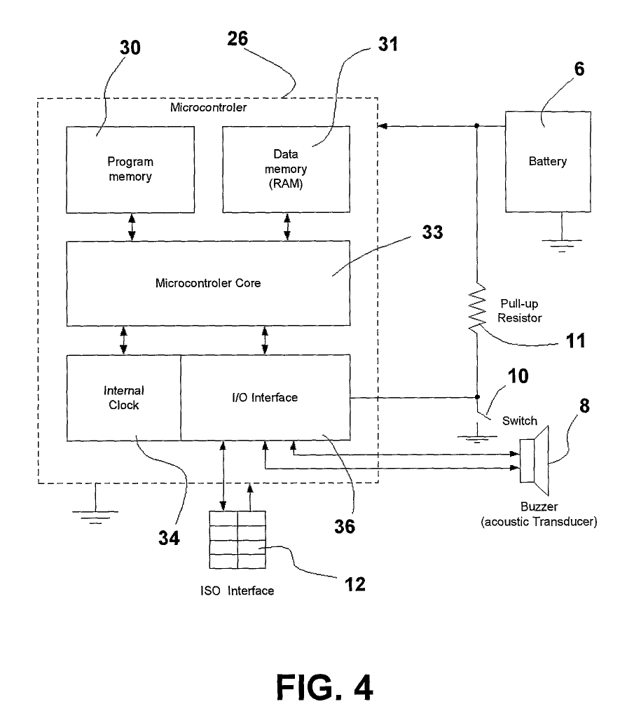

In FIG. 4, the switch 10 is combined with a pull-up resistor 11. The activation signal is generated when the switch 10 is closed and the voltage variation is sensed by an I/O interface 36. It has a connection located between the switch 10 and the pull-up resistor 11. The card 2 may also be switched on through the ISO 7816 interface 12, for instance by powering up the microcontroller 26 or sending an activation signal to it. FIG. 4 also shows another possible configuration. In this case, the personalization data is stored in a portion of the RAM 31 as long as it remains connected to the battery 6. This allows, as an additional security feature, that the content of the RAM 31 be erased if the battery 6 is disconnected, which is likely to happen when someone attempts to open or tamper with the card 2. Other security features are possible as well.

The card 2 is first manufactured without personalization data and cannot be distinguished from any other similar cards. Instead, the microcontroller 26 is preferably programmed to generate such data from a random internal number during the personalization phase. The personalization phase is initiated following one or more events, for instance when the card 2 is inserted in a smart card reader connected to or otherwise exchanging information with the transaction system. The personalization phase can also be carried out at the factory once a major part of the card 2 is completed. For instance, the personalization phase can be achieved at the factory when powering up the microcontroller 26 for the first time. It can be a manual, automatic or semi-automatic procedure.

The generation of a random internal number is made by a random or pseudo-random sequence generator that generates a number that cannot be predicted. The random internal number generator is designed so that it is statistically improbable that two cards have identical internal numbers. Many methods are possible to achieve this result and two or more of these methods can be combined. For instance, the random internal number can be obtained from a noise generated by a random noise generator coupled to appropriate means for sensing and sampling the noise produced by the noise generator. These means can be programmed in the microcontroller 26. An example of a noise generator is a noisy diode. It can also be a reading of the initial random state of a part of the RAM 31 when the microcontroller 26 is powered up, the output of a noise sensor reading an external electrical or acoustical random noise, or the accumulated count from a very precise timer whose value is read by appropriate means. In the latter case, the timer may be started when the card 2 was manufactured or at a random time thereafter. Other embodiments are possible as well.

Once the random internal number is generated, segments of the number can be used as the personalization data. For instance, if the random internal number has a length of 21 bytes, the first or the last 5 bytes can be used as the serial number and the other 16 bytes used as the key number. Of course, many other methods are possible. It is further possible to use the number in a mathematical algorithm, such as a one-way hashing function or the like, to generate another number or other numbers to be used as the personalization data. The card 2 can even be designed to generate two or more random internal numbers, using the same or a different method, and use these numbers for obtaining the personalization data. These personalization data are preferably not altered or modified once they are generated.

The personalization data can also be obtained using a random seed number in addition to the random internal number or numbers in order to further increase the randomness of the personalization data. In that case, the card 2 is provided with the unique seed number before the personalization phase, either as part of the manufacture process or at a later time through the ISO 7816 interface 12. The seed number is combined or otherwise used with the random internal number, for instance through a mathematical algorithm such as a one-way hashing function or the like, as programmed in the microcontroller 26. Thereafter, the random seed is preferably overwritten or is otherwise erased or eliminated since it is only used to generate the personalization data. The personalization data has to be generated in such as way that they should not be deducted even if someone knows the seed number.

Once the personalization data is generated, it is necessary to transmit them to the transaction system since it is not otherwise possible to associate and/or decipher data received from a genuine card with the record of the card 2 in the course of a transaction. Depending on the applications and where the personalization phase is carried out, this transfer of data is either achieved in an unencrypted manner, for instance when the card 2 inserted in a smart card reader, or in an encrypted manner over another link, such as when using an acoustic link over a telephone line. This transfer of personalization data should be limited to one time only. In all cases, the transfer of personalization data needs to be carried out before the card 2 can be used normally by the end user.

The end user may be required to go through an activation phase before using the personalized card 2. In that case, the end user would be required to transmit to the transaction system independent data identifying him or her so as to confirm that the personalized card 2 is in the hand of its intended end user. Such independent data may include one or more personal identification numbers (PINs) issued to the end user, either with the card 2 or independently for more security. PINs have the advantage of increasing the chances that the card 2 is used by its intended end user. The independent data may further include identification data appearing on the card 2 itself or pre-programmed in one of its memories but used solely to verify the identity of the card 2. Because it is not utilized to generate authentication streams during normal use of the card 2, the presence of the independent data does not compromise security during use. For example, the independent data may be in the form of a card number embossed or otherwise written on one of the surfaces 14, 16 of the card 2. It can also be a serial number readable from the microcontroller 26.

In use, the microcontroller 26 preferably increments or decrements the counter value by 1 or any other number each time the card 2 is activated throughout the life thereof The update of the counter is preferably made before generating a data stream. It can also be updated thereafter. Accordingly, upon activation of the card 2, the serial number or any other identification number and the updated counter value are obtained from the corresponding memory of the card 2, such as the RAM 31 or the EEPROM 32, to form portions of a data stream that is to be transferred to the transaction system. The data stream also includes a signature, which is generated using the updated counter value and at least a portion of the key number, all of which are used in a cryptographic algorithm. The microcontroller 26 produces sequences of electrical signals corresponding to the data stream and sends them to the I/O interface 36, where they are sent to the acoustic transducer element 8 or the ISO 7816 interface 12, or both.

Once the data stream is received, the transaction system generally finds the record of the card 2 or that of end user with the serial number or any other number, and then determines with the signature if the transaction is legitimate or not. The counter value is also verified, if any. Accordingly, if the counter value of the current transaction is below or equal to that of the last transaction, this means that someone is trying to use the same data stream twice or an expired data stream. Any suspect transaction would be denied and the protocol in case of the detection of a fraud is initiated. The card 2 and the corresponding transaction system may also use a communication procedure involving challenge questions and replies.

It should be understood that the implementations of many of the features of the above-described authentication device are exemplary only. Considerable variations are possible within the scope of the present invention, various features of which may be used independently or in different combination. Moreover, the term <<card>> used in the detailed description is only as an example and the present invention is not limited to cards only.

What is claimed is:

1. An authentication device for a transaction system, the card comprising:
first means for activating a personalization phase of the card;
second means for generating a random internal number;
third means located on the card for generating personalization data using at least partially the random internal number;
fourth means for recording the personalization data; and
fifth means for transmitting the personalization data to the transaction system.

2. An authentication device in accordance with claim 1, wherein the second means comprise a random noise generator coupled with means for sensing and sampling the noise produced by the random noise generator.

3. An authentication device in accordance with claim 2, wherein the random noise generator comprises a noisy diode.

4. An authentication device in accordance with claim 1, wherein the second means comprise means for reading the initial random state of at least a part of a memory.

5. An authentication device in accordance with claim 1, wherein the second means comprise means for sensing an external electrical or acoustical random noise.

6. An authentication device in accordance with claim 1, wherein the second means comprise a timer coupled with means for reading a timer value.

7. An authentication device in accordance with claim 1, wherein the device is a card.

8. An authentication device in accordance with claim 7, wherein the card is an ISO 7816 smart card.

9. An authentication device in accordance with claim 8, wherein the fifth means comprise an ISO 7816 interface, the first means comprising an activation signal sent through the ISO 7816 interface.

10. An authentication device in accordance with claim 1, wherein the fifth means comprise an acoustic transducer element.

11. An authentication device in accordance with claim 1, wherein the second, third and fourth means are provided on a microcontroller.

12. An authentication device in accordance with claim 11, wherein the fourth means comprise a memory module provided on the microcontroller.

13. An authentication device in accordance with claim 1, wherein the first means comprise a switch.

14. An authentication device in accordance with claim 1, wherein the first means comprise means for sensing an external activation signal.

15. An authentication device in accordance to claim 1, further comprising sixth means for supplying power to the microcontroller.

16. An authentication device in accordance with claim 15, wherein the sixth means comprise a battery.

17. An authentication device in accordance with claim 15, wherein the sixth means comprise an electrical connection to a power supply made through an ISO 7816 interface.

18. An authentication device in accordance to claim 1, further comprising means for disabling operation of the device in response to attempted tampering therewith.

19. An authentication device for a transaction system, the device comprising:
a data output device;
a random internal number generator; and
a microcontroller connected to the data output device and being programmed to:
during a personalization phase, generate personalization data using at least partially the random internal number, the personalization data being transmitted to the transaction system through the data output device; and
during normal use of the device, after the personalization phase, generate an authentication stream for output by the data output device, the program incorporating an algorithm, which on each use, generates a different authentication stream based at least partially on the personalization data.

20. An authentication device in accordance with claim 19, wherein the random internal number generator comprises a random noise generator coupled with means for sensing and sampling the noise produced by the random noise generator.

21. An authentication device in accordance with claim 20, wherein the random noise generator comprises a noisy diode.

22. An authentication device in accordance with claim 19, wherein the random internal number generator comprises means for reading the initial random state of at least a part of a memory.

23. An authentication device in accordance with claim 19, wherein the random internal number generator comprises means for sensing an external electrical or acoustical random noise.

24. An authentication device in accordance with claim 19, wherein the random internal number generator comprises a timer coupled with means for reading a timer value.

25. An authentication device in accordance with claim 19, wherein the device is a card.

26. An authentication device in accordance with claim 25, wherein the card is an ISO 7816 smart card.

27. An authentication device in accordance with claim 26, wherein the data output device comprises an ISO 7816 interface, the first means comprising an activation signal sent through the ISO 7816 interface.

28. An authentication device in accordance with claim 19, wherein the data output device comprises an acoustic transducer element.

29. An authentication device in accordance with claim 19, further comprising a switch.

30. An authentication device in accordance with claim 19, further comprising means for sensing an external activation signal.

31. An authentication device in accordance to claim 19, further comprising means for supplying power to the microcontroller.

32. An authentication device in accordance with claim 31, wherein the means for supplying power comprise a battery.

33. An authentication device in accordance with claim 19, wherein the means for supplying power comprise an electrical connection to a power supply made through an ISO 7816 interface.

34. An authentication device in accordance to claim 19, further comprising means for disabling operation of the device in response to attempted tampering therewith.

35. A method of personalizing an authentication device, the method comprising:
generating a random internal number inside the device;
generating personalization data inside the device using at least partially the random internal number; and
recording the personalization data in a memory provided on the device.

36. A method in accordance with claim 35, further comprising:
subsequently transmitting the personalization data to a transaction system with which the device is designed to operate.

37. A method in accordance with claim 36, wherein subsequently transmitting the personalization data to a transaction system comprises outputting the personalization data through an ISO 7816 interface.

38. A method in accordance with claim 36, wherein subsequently transmitting the personalization data to a transaction system comprises outputting the personalization data through an acoustic transducer element.

39. A method in accordance with claim 35, wherein generating a random internal number comprises generating a random noise, sensing the noise and sampling it.

40. A method in accordance with claim 35, wherein generating a random internal number comprises reading the initial random state of at least a part of a memory.

41. A method in accordance with claim 35, wherein generating a random internal number comprises sensing an external electrical or acoustical random noise.

42. A method in accordance with claim 35, wherein generating a random internal number comprises reading a timer value.

43. A method in accordance with claim 35, wherein generating personalization data inside the device comprises using portions of the random internal number as the personalization data.

44. A method in accordance with claim 35, wherein generating personalization data inside the device comprises using a mathematical algorithm pre-recorded on the device and in which at least a portion of the random internal number is used as a variable.

45. A method in accordance with claim 44, wherein the mathematical algorithm includes a one-way hashing function.

46. A method in accordance with claim 35, wherein generating personalization data comprises generating a serial number and a key number.

47. A method in accordance with claim 35, further comprising:
recording on the device a random seed number before generating a random internal number; and
generating the personalization data using a mathematical algorithm in which at least a portion of the random internal number and the random seed number are used as variables.

48. A method in accordance with claim 47, wherein the mathematical algorithm includes a one-way hashing function.

49. A method in accordance with claim 35, further comprising activating personalization of the device by supplying power to a microcontroller, located on the card, for a first time.

50. A method in accordance with claim 35, further comprising activating personalization of the device by sending an activation signal to a microcontroller located on the card.
